(19) United States
(12) Patent Application Publication
(10) Pub. No.: US 2022/0049820 A1
(43) Pub. Date: Feb. 17, 2022

(54) GAS EXPANSION AND FLUID COMPRESSION STATION

(71) Applicant: GRTGAZ, Bois Colombes (FR)

(72) Inventors: Yannick ONFROY, Bois Colombes (FR); Alban SESMAT, France (FR)

(21) Appl. No.: 17/309,809

(22) PCT Filed: Dec. 20, 2019
(86) PCT No.: PCT/FR2019/053266

§ 371 Date: Jun. 20, 2021

(30) Foreign Application Priority Data
Dec. 21, 2018 (FR) 1873933

(51) Int. Cl. F17D 1/04; H02K 7/18; H02K 11/00

(52) U.S. Cl. CPC F17D 1/04; H02K 11/0094; H02K 7/1823

(57) ABSTRACT

Disclosed is a station (100) for expanding a flow of gas having, at the inlet, a temperature Tₐ and a pressure Pₐ, that comprises:
an expansion valve (105) for recovering mechanical expansion energy configured to reduce the pressure of the gas flow to a pressure P_{b} and to a temperature T_{b} such that P_{b}<Pₐ and T_{b}<Tₐ;
a compressor (110) for compressing a flow of fluid having, at the inlet, a temperature T_{c} and a pressure P_{c}; the expansion valve and the compressor are linked mechanically such that the movement of the expansion valve when the gas expands causes the compressor to be actuated such that the fluid is compressed to a pressure P_{d} and a temperature T_{d} such that P_{d}>P_{c} and T_{d}>T_{c}; and
a heat exchanger (115) for exchanging heat between the gas flow at the outlet or inlet of the expansion valve and the fluid flow at the outlet or inlet of the compressor in order to heat the gas and cool the fluid.

### TECHNICAL FIELD OF THE INVENTION

The present invention envisages a gas expansion and fluid compression station utilizing mechanical expansion energy recovery. It applies in particular to gas expansion stations located away from an electricity grid.

### STATE OF THE ART

The expansion of a gas causes the formation of unavoidable energy (expansion energy), which is currently little or badly used and consequently mostly or totally lost.

The expansion of a gas from an upstream network, such as a transportation infrastructure, to a downstream network occurs in an expansion station located at the junction of the downstream and upstream networks. Some expansion stations are located in places where the electricity supply is sporadic or non-existent. This limitation means that the design of expansion stations located in such places must be essentially mechanical. However, more advanced models require electricity so that certain elements (screens, sensors, transmitters, valves) can operate. In addition, the temperature of the expanded gas is generally too low for this gas to be injected into the downstream network; therefore, a heat exchange must occur for the gas to be suitable for injection.

Expansion stations are known in which the heat from the expansion energy is used to generate electricity via a generator coupled with the expansion turbine. This electricity is then used to power a heat exchanger and heat the expanded gas.

Similarly, there are stations in which the expanded gas is subsequently heated by combusting a portion of the gas to heat the remainder before injection into the downstream network.

It is also possible to generate electricity with a motor fueled with gas collected from the upstream or downstream network.

However, though the existing solutions enable the unavoidable energy to be recovered, none make it possible to store this energy to be used at the right time. In addition, heating the expanded gas requires significant resources, which are incompatible with the size and cost of the stations.

Documents US 2018/073802 and WO 2007/087713, which respectively describe the methods for storing the energy as liquid air or liquid gas, are known.

Because of this objective, these methods are very complicated and therefore expensive to implement; they can only be utilized on interfaces between a high-pressure and a low-pressure gas network with high flow rates. For example, the method described in document US 2018/073802 requires utilizing five compressors and seven expansion valves. In addition, generators and electric motors also result in significant efficiency losses. Electrically autonomous expansions stations are not possible with these methods.

### DESCRIPTION OF THE INVENTION

The present invention aims to remedy all or part of these drawbacks.

To this end, the present invention envisages an expansion station for expanding a flow of gas having, at the inlet, a temperature Tₐ and a pressure Pₐ, which station comprises:
an expansion valve for recovering mechanical energy configured to reduce the pressure of the gas flow to a pressure P_{b} and to a temperature T_{b} such that P_{b}<Pₐ and T_{b}<Tₐ;
a compressor (110) for compressing a flow of fluid having, at the inlet, a temperature T_{c} and a pressure P_{c}; the expansion valve and the compressor are linked mechanically such that the movement of the expansion valve when the gas expands causes the compressor to be actuated such that the fluid is compressed to a pressure Pₐ and a temperature Tₐ such that Pₐ>P_{c} and Tₐ>T_{c}; and
a heat exchanger for exchanging heat between the gas flow at the outlet or inlet of the expansion valve and the fluid flow at the outlet or inlet of the compressor in order to heat the gas and cool the fluid.

Because of these provisions, the expansion energy is stored as compressed gas in the tank so it is possible to use this energy later, while at the same time heating the gas flow so it can be injected into a downstream network without adding outside energy.

In some embodiments, the expansion station that is the subject of the invention comprises a common shaft between an expansion valve and a compressor.

Because of these provisions, the expansion valve drives the compressor with very low mechanical losses, thus increasing the expansion station's efficiency.

In some embodiments, the expansion station that is the subject of the invention comprises a free piston that is moved by the gas in an expansion chamber and compresses the fluid in a compression chamber.

Because of some provisions, the fluid's pressure at the compressor outlet may be higher than the gas pressure at the expansion station's inlet.

In some embodiments, the expansion station that is the subject of the invention comprises a generator connected to an outlet of the heat exchanger, the generator being configured to generate electricity from compressed fluid.

In some embodiments, the expansion station that is the subject of the invention comprises a means for storing electricity generated by the generator, this storage means supplying electricity to at least one element of said expansion station.

These embodiments make it possible to transform the energy stored in the form of stored gas into electrical energy to power the expansion station or other piece of equipment connected electrically to the generator.

In some embodiments, the expansion station that is the subject of the invention comprises a heat exchanger between a flow of fluid exiting a compressor and a flow of gas supplied to said station upstream of an expansion valve.

In some embodiments, the fluid exiting the generator is supplied on input to the compressor.

These embodiments make it possible to produce a fluid cycle; the fluid can be chosen for its ability to best store the expansion energy.

In some embodiments, the expansion station that is the subject of the invention comprises a tank for storing the fluid exiting the heat exchanger.

In some embodiments, the fluid is air.

These embodiments make it possible to use a simple design for the expansion station.

In some embodiments, the heat exchanger is configured to be at least partially buried in the ground.

These embodiments make it possible to optimize the heat exchanger's operation in terms of ability to heat the gas and cool the fluid.

In some embodiments, the station that is the subject of the invention comprises a plurality of pairs, each comprising an expansion valve for recovering mechanical energy and a compressor that are linked mechanically such that the movement of an expansion valve during the expansion of the gas activates the compressor.

These embodiments increase the expansion/compression performance.

In some embodiments, the heat exchanger is positioned between two stages of expansion valves and/or compressors.

These embodiments enable an intermediate heat exchange.

In some embodiments, the expansion station that is the subject of the invention comprises a heat exchanger between a flow of fluid from a compressor and a flow of gas supplied to said station.

### BRIEF DESCRIPTION OF THE FIGURES

Other advantages, aims and particular features of the invention will become apparent from the non-limiting description that follows of at least one particular embodiment of the expansion station that is the subject of the present invention, with reference to drawings included in an appendix, wherein:

FIG. 1 represents, schematically, a first particular embodiment of the expansion station that is the subject of the invention;

FIG. 2 represents, schematically, a second particular embodiment of the expansion station that is the subject of this invention;

FIG. 3 represents, schematically, a third particular embodiment of the expansion station that is the subject of this invention; and

FIG. 4 represents, schematically, a mechanical coupling of an expansion valve and a compressor by a free piston.

### DESCRIPTION OF THE EMBODIMENTS

The present description is given in a non-limiting way, in which each characteristic of an embodiment can be combined with any other characteristic of any other embodiment in an advantageous way.

Note that the figures are not to scale.

Note: the term “gas” refers, for example, to methane.

Note: “upstream network” means, for example, a gas transportation network.

Note: “downstream network” means, for example, a gas distribution network.

Note: “fluid” means, for example, air.

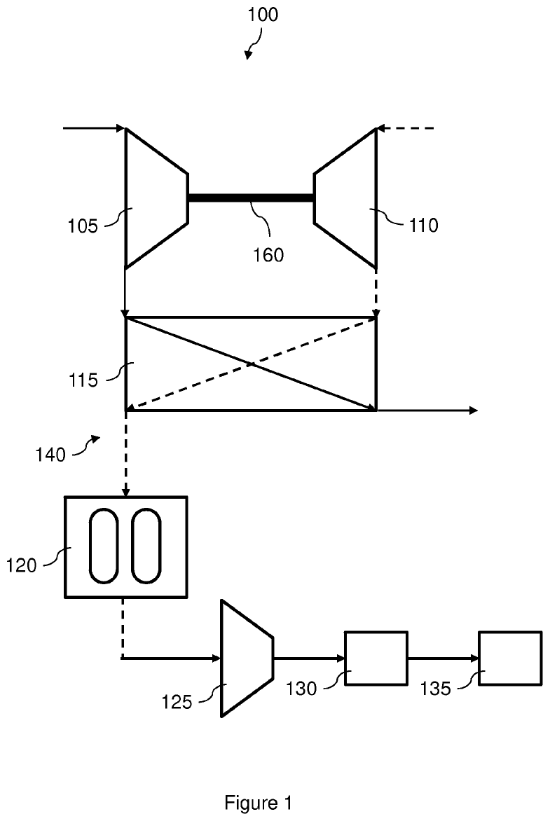

In FIGS. 1 to 3, the path of the fluid is shown by dashed lines, whereas the path of the gas is shown by continuous lines.

FIG. 1, which is not to scale, shows a schematic view of an embodiment of the expansion station 100 that is the subject of the invention. This expansion station 100 for expanding a flow of gas having a temperature Tₐ and a pressure Pₐ at the inlet comprises:
An expansion valve 105 for recovering mechanical energy configured to reduce the pressure of the gas flow to a pressure P_{b} and a temperature T_{b} such that P_{b}<Pₐ and T_{b}<Tₐ;
a compressor 110 for compressing a flow of fluid having a temperature T_{c} and a pressure P_{c} at the inlet, driven by the activation of the expansion valve, and configured to increase the pressure of the fluid to a pressure P_{d} and a temperature T_{d} such that P_{d}>P_{c} and T_{d}>T_{c}; and
a heat exchanger 115 for exchanging heat between the gas flow at the outlet or inlet of the expansion valve and the fluid flow at the outlet or inlet of the compressor in order to heat the gas and cool the fluid.

The expansion valve 105 is, for example, any type of gas expansion turbine known to the person skilled in the art in the field of expanding a gas between an upstream and a downstream gas network. For this reason, the implementation choice of the expansion valve 105 depends on the value of the incoming gas pressure Pₐ and the value of the outgoing gas pressure P_{b}. Typically, the incoming gas pressure Pₐ is of the order of 60 bar and the value of the outgoing pressure P_{b} is of the order of 20 bar.

The expansion valve may be, for example, a multi-stage axial flow turbine 105.

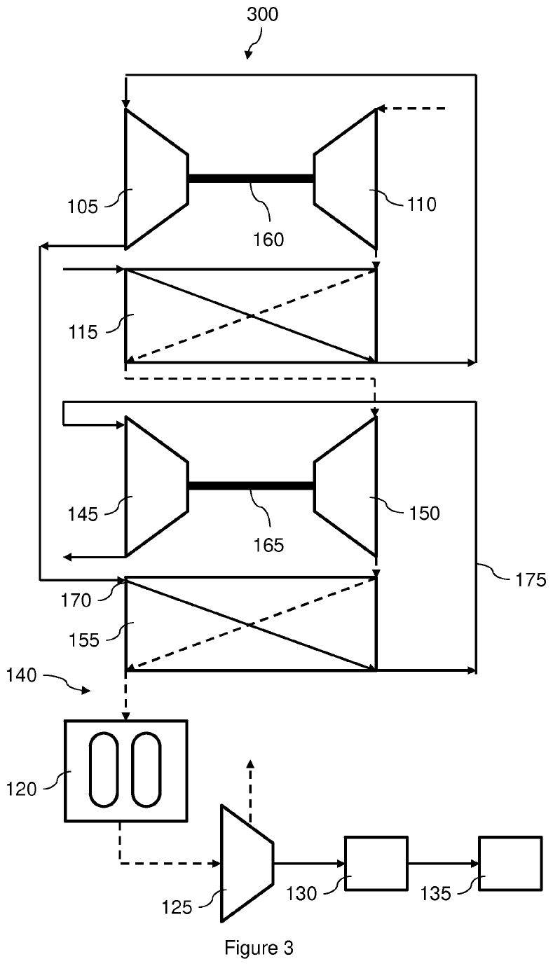

In some variants, such as the one shown in FIG. 3, the station 300 comprises a plurality of successive expansion valves 105 for recovering mechanical energy.

The compressor 110 is a compressor for fluid in gaseous form of any type known to the person skilled in the art in the field of transferring mechanical energy into gaseous energy. For this reason, the implementation choice of the compressor 110 depends on the value of the incoming fluid pressure Pₐ and the value of the outgoing fluid pressure P_{b}.

The compressor 110 is, for example, a volumetric compressor, e.g. a piston or diaphragm compressor, possibly with multiple stages. The compressor 110 is, for example, configured to receive air at atmospheric pressure on input and supply compressed air at a pressure between 100 and 200 bars on output.

In some variants, the compressor 110 is replaced by any other known means of compressing a gas.

The expansion valve 105 for recovering mechanical energy and the compressor 110 are mechanically linked so that the movement of the expansion valve 105 during the expansion of the gas activates the compressor 110 in such a way that the gas is compressed. For example, a common shaft 160 is attached to the expansion valve 105 and put in translation or rotation about itself during the movement of the expansion valve 105. This shaft 160 is also attached to the compressor 110 in such a way that the movement of the shaft 160 drives the operation of the compressor 110 and therefore the compression of the fluid.

The expansion valve 145 for recovering mechanical energy and the compressor 150 are mechanically linked so that the movement of the expansion valve 145 during the expansion of the gas activates the compressor 150 in such a way that the gas is compressed. For example, a common shaft 165 is attached to the expansion valve 145, this shaft being put in translation or in rotation about itself during the movement of the expansion valve 145. This shaft 165 is also attached to the compressor 150 in such a way that the movement of the shaft 165 drives the operation of the compressor 150 and therefore the compression of the fluid.

Because of these mechanical links, the expansion valves 105 and 145 drive the compressors 110 and 150 with very low mechanical losses, thus increasing the expansion station's efficiency.

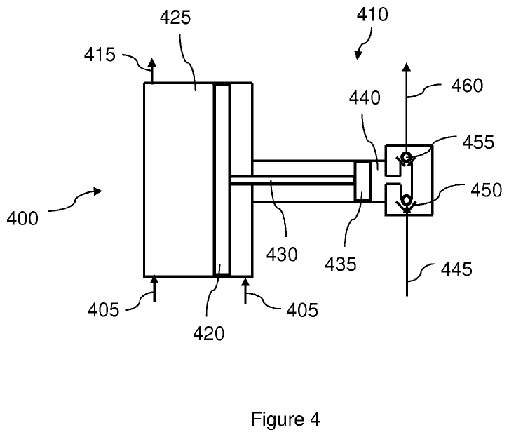

FIG. 4 shows a paired expansion valve 400 at left and free piston compressor 410 at right. The expansion valve 400 comprises an expansion chamber 425 fitted with at least one high-pressure gas inlet 405 and one low-pressure gas outlet 415. In the expansion chamber 425, an expansion piston 420 is put into back-and-forth movement by the pressure of the gas injected on either side of the piston 420 by means of the inlets 405. The force resulting from the application of this pressure on the expansion piston is transmitted, by means of a shaft 430, to a compression piston 435 that compresses the fluid in a compression chamber 440. Together, the pistons 420 and 435, and the shaft 430 constitute a free piston.

Valves 450 and 455 provide hermeticity and the direction of movement of the fluid, from a low-pressure fluid inlet 445 to a high-pressure fluid outlet 460. The system for controlling the input of gas into the expansion chamber 425 and the output of gas from the chamber 425 is not described here as it is well known to the person skilled in the art.

In this way, a free piston is moved by the gas in the expansion chamber 425, and compresses the fluid in the compression chamber 440. The expansion valve drives the compressor with very low mechanical losses, thus increasing the expansion station's efficiency. Note that the fluid's pressure at the compressor outlet may be higher than the gas pressure at the expansion station's inlet, depending on the ratio of the surfaces of the pistons 420 and 435.

In a variant, the free piston is replaced by membranes, as in diaphragm booster pumps of a known type.

In some variants, the station 100 comprises a gearbox between the expansion valve 105, especially if the expansion valve is a turbine, and the compressor 110 to enable different rotation speeds and different torques between the expansion valve 105 and the compressor 110.

The heat exchanger 115 is, for example, a tubular or finned heat exchanger. In some variants, the heat exchanger 115 may comprise an intermediate heat-transfer circuit.

Inside the heat exchanger 115, the ratio of the pressures P_{b} and Pₐ remains unchanged, while temperature T_{b} increases and temperature T_{d} decreases. The heat exchanger 115 is configured such that, on exit, the temperature of the gas is compatible with a range of temperature values accepted by the downstream network. For example, the gas exiting the heat exchanger 115 is approximately at ambient temperature. Typically, the inlet temperature value Tₐ is of the order of 5° C., and the temperature on exit from the heat exchanger 115 is of the order of 10° C. or 20° C.

The fluid exiting the heat exchanger 115 may be released into the environment around the expansion station 100.

This fluid may also be stored in a storage tank 120 for the compressed fluid cooled in the heat exchanger 115.

This fluid may also be supplied directly to an electricity generator 125, possibly after being stored in a compressed fluid tank 120.

This fluid may also be injected into a compressed air network.

The tank 120 is, for example, a bottle configured to store the fluid at a specified pressure. In some variants, the tank 120 is made up of several bottles.

In some variants, the tank 120 is configured to be connected to a compressed gas network. In other variants, the station 100 comprises no tank, and the compressed gas is injected directly into a gas network.

The heat exchange can be performed by an intermediate heat-transfer fluid, and a heat exchanger can be added to cool the compressor's heat-transfer fluid and heat the natural gas. For example, this heat-transfer fluid is oil.

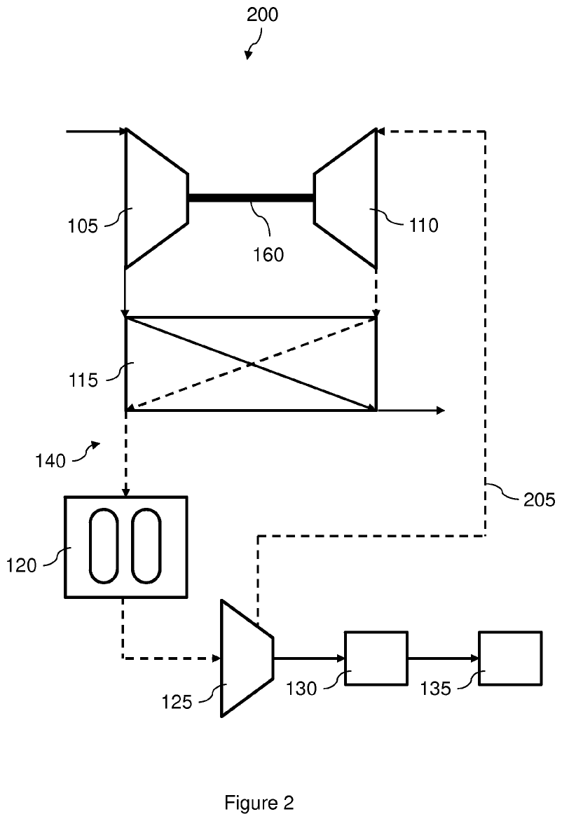

In some embodiments, such as those shown in FIGS. 1 and 2, the station, 100 or 200, comprises a generator 125 configured to generate electricity from the compressed fluid at the outlet 140 of the heat exchanger 115.

In a variant, a generator is placed at the output of a compressor and upstream from the heat exchanger.

In some variants, the generator 125 is configured to generate electricity from the fluid stored in a tank 120.

In some embodiments, a heat exchanger at the generator's outlet transfers the cold energy coming from the turbine 125 to supply a cold network or cool a datacenter.

Note that, in the embodiment described in FIG. 2, the fluid can be air, or any fluid selected for its ability to best store the expansion energy, since it circulates in a closed loop.

The generator 125 is, for example, a generator of electricity from compressed gas operating by actuating a turbine with the flow of gas released by the tank 120. This generator 125 may be, for example, a three-phase asynchronous type.

In some embodiments, such as those shown in FIGS. 1 and 2, the station, 100 or 200, comprises a storage means 130 for electricity generated by the generator.

The energy storage means 130 is, for example, a battery.

In some embodiments, such as those shown in FIGS. 1 and 2, the station, 100 or 200, the electricity powers at least one element 135 of said expansion station.

The element 135 may be of any kind, provided it requires an electricity supply. This element 135 is, for example, a screen, a sensor, an actuator, or a detector. For example, this element 135 is a valve or motor.

In some variants, the electricity powers a piece of equipment external to the expansion station, 100 or 200, i.e. one that is not part of the elements required for operating said expansion station 100 or 200.

In some embodiments, such as that represented in FIG. 2, the fluid exiting the generator 115 is supplied to the compressor 110 inlet by a duct 205.

In some embodiments, such as those shown in FIGS. 1 and 2, the station, 100 or 200, the fluid is air, for example. This fluid can be of any other type advantageous in terms of energy storage capacity.

In some embodiments, such as those shown in FIGS. 1 and 2, the station, 100 or 200, the heat exchanger 115 is configured to be at least partially buried in the ground.

In some embodiments, such as that represented in FIG. 3, the station 300 comprises a plurality of expansion valves 105, 145 for recovering mechanical energy and/or a plurality of compressors 110, 150.

Each expansion valve, 105 or 145, is linked mechanically to a compressor, respectively 110 and 150, such that the movement of this expansion valve during the expansion of the gas actuates the compressor.

In some embodiments, such as that represented in FIG. 3, a first heat exchanger 115 is placed between two pairs of expansion valves 105 and 145 and compressors 110 and 150.

A second heat exchanger 155 is placed downstream from a pair of expansion valves 145 and compressor 150. This second heat exchanger 155 has an inlet 170 that receives the flow of gas exiting the expansion valve 105. Once this gas has cooled, a duct 175 takes this gas to the second expansion valve 145. The expanded gas exits the expansion station 300 at the outlet of this expansion valve 145.

In some embodiments, such as that shown in FIG. 3, the station 300 comprises a heat exchanger 115 between a flow of fluid exiting a compressor 110 and a flow of gas supplied to said station upstream of an expansion valve. In the embodiment shown in FIG. 3, a heat exchanger 115, 155 is placed upstream of each expansion valve/compressor pair.

Reheating the gas before each expansion stage stops the gas temperature from falling too low and prevents the formation of hydrates (i.e. the sublimation of molecules containing water), which could damage the expansion valve 105 or 155. Similarly, cooling the fluid at each compression stage prevents the degradation of some parts of the compressor 150 by fluid that is too hot.

In some variants, such as those shown in FIGS. 1 and 2, the heat exchanger 115 is placed downstream of each expansion valve 105 and/or each compressor 110.

1. A station for expanding a flow of gas having, at the inlet, a temperature Tₐ and a pressure Pₐ, comprising:
an expansion valve for recovering mechanical energy configured to reduce the pressure of the gas flow to a pressure P_{b} and to a temperature T_{b} such that P_{b}<Pₐ and T_{b}<Tₐ;
a compressor for compressing a flow of fluid having, at the inlet, a temperature T_{c} and a pressure P_{c}; the expansion valve and the compressor are linked mechanically such that the movement of the expansion valve when the gas expands causes the compressor to be actuated such that the fluid is compressed to a pressure P_{d} and a temperature T_{d} such that P_{d} >P_{c} and T_{d}>T_{c}; and
a heat exchanger for exchanging heat between the gas flow at the outlet or inlet of the expansion valve and the fluid flow at the outlet or inlet of the compressor in order to heat the gas and cool the fluid.

2. The expansion station according to claim 1, which comprises a common shaft between an expansion valve and a compressor.

3. The expansion station according to claim 1, which comprises a free piston that is moved by the gas in an expansion chamber and compresses the fluid in a compression chamber.

4. The expansion station according to claim 1, which comprises a generator configured to generate electricity from the fluid at the outlet of the heat exchanger.

5. The expansion station according to claim 4, which comprises a means for storing electricity generated by the generator, this storage means supplying electricity to at least one element of said expansion station.

6. The expansion station according to claim 5, which comprises a heat exchanger between a flow of fluid exiting a compressor and a flow of gas supplied to said station upstream of an expansion valve.

7. The expansion station according to claim 4, wherein the electricity powers at least one element of said expansion station.

8. The expansion station according to claim 4, wherein the fluid exiting the generator is supplied on input to the compressor.

9. The expansion station according to claim 1, wherein the fluid is air.

10. The expansion station according to claim 1, which comprises a storage tank for the compressed fluid cooled in the heat exchanger.

11. The expansion station according to claim 10, which comprises a generator configured to generate electricity from the fluid at the outlet of the fluid storage tank.

12. The expansion station according to claim 1, wherein the heat exchanger is configured to be at least partially buried in the ground.

13. The expansion station according to claim 1, which comprises a plurality of expansion valves for recovering mechanical energy and/or a plurality of staged compressors.

14. The expansion station according to claim 13, wherein the heat exchanger is positioned between two stages of expansion valves and/or compressors.

15. The expansion station according to claim 1, which comprises a heat exchanger between a flow of fluid from a compressor and a flow of gas supplied to said station.
